(19) United States
(12) Patent Application Publication
(10) Pub. No.: US 2017/0124653 A1
(43) Pub. Date: May 4, 2017

(54) TOOL FOR ASSESSING FINANCIAL ACCOUNTS

(71) Applicant: VOYA SERVICES COMPANY, Atlanta, GA (US)

(72) Inventors: Zachary James Dunkin, Bussey, IA (US); Kunnel Abraham, North Wales, PA (US); Benjamin Michael Wyatt, Ames, IA (US); Benjamin Tucker Fust, Bondurant, IA (US); Derek Alan Moore, Madrid, IA (US)

(21) Appl. No.: 14/931,371

(22) Filed: Nov. 3, 2015

(51) Int. Cl. G06Q 40/06; G06F 3/0484

(52) U.S. Cl. CPC G06Q 40/06; G06F 3/04842

(57) ABSTRACT

An example method includes receiving, at a processing module from a database module, data pertaining to one of more financial accounts, and determining, by the processing module based on the received data, whether each financial account meets one or more criteria. The method also includes presenting visually, on an interactive user interface, an indication of the financial accounts that do not meet at least one of the criteria, and an indication of a status of those financial accounts with respect to each of the criteria.

### TECHNICAL FIELD

This disclosure relates to monitoring financial accounts, and more particularly to identifying and resolving issues related to opening and activating a financial account.

### BACKGROUND

A financial institution can manage financial accounts on behalf of account holders. For example, a customer can open a financial account with a financial institution, and conduct transactions with others using the financial account.

Financial institutions often specify that certain requirements or criteria be met in opening and activating a financial account. As an example, in some cases, a financial institution may require a customer to provide certain information or documentation before a financial account is opened and activated for use by the customer. As another example, a financial institution may require that a financial account be furnished with a minimum acceptable balance. Financial accounts that meet the specified requirements or criteria are sometimes referred to as being in “good order.” Financial accounts that do not meet one or more of the specified requirements or criteria are sometimes referred to as not being in good order.

### SUMMARY

This disclosure describes various systems and methods for assessing the status of financial accounts, and identifying financial accounts that are not in good order. Implementations also can be used to identify corrective actions that can be performed with respect to the financial accounts, such that the financial accounts are placed in good order and fully activated. One or more of the described implementations can assist users (e.g., agents of a financial account, such as administrators and customer service agents) in identifying and resolving issues related to opening and activating financial accounts. This can be beneficial, for example, as it allows users to assist customers more efficiently and with greater accuracy. This can also be beneficial, for example, as it allows the system to process and manage information related to financial accounts more quickly and efficiently.

In general, in an example, a method includes receiving, at a processing module from a database module, data pertaining to one of more financial accounts, and determining, by the processing module based on the received data, whether each financial account meets one or more criteria. The method also includes presenting visually, on an interactive user interface, an indication of the financial accounts that do not meet at least one of the criteria, and an indication of a status of those financial accounts with respect to each of the criteria.

Implementations of this aspect may include or more of the following features.

In some implementations, the method can further include receiving, via the interactive graphical user interface, an input from a user indicative of the user's selection of a particular financial account. The method also includes, responsive to receiving the input, presenting visually, on the interactive user interface, information describing corrective actions that can be performed with respect to the selected financial account, such that performance of the corrective actions results in the selected financial account meeting the one or more criteria. In some implementations, the method can further include receiving, via the interactive graphical user interface, a second input from the user, and responsive to receiving the second input, determining that the corrective actions were performed. In some implementations, the method can further include, responsive to determining that the corrective actions were performed, presenting visually, on the interactive user interface, an indication of an updated status of the selected financial accounts with respect to each of the criteria.

In some implementations, at least one criterion can pertain to one or more documents associated with establishing a financial account, where a financial account does not meet the criterion if any of the one or more documents for the financial account is deemed to be missing based on the received data. The corrective actions can include providing the one or more documents that are deemed to be missing.

In some implementations, at least one criterion can pertain to one or more documents associated with establishing a financial account, where a financial account does not meet the criterion if any of the one or more documents for the financial account is deemed to be illegible based on the received data. The corrective actions can include providing one or more replacement documents for the one or more documents that are deemed to be illegible.

In some implementations, at least one criterion can pertain to a monetary balance of a financial account, where a financial account does not meet the criterion if the monetary balance for the financial account is less than or equal to a threshold balance.

In some implementations, at least one criterion can pertain to an anticipated distribution of funds of a financial account with respect to one or more financial assets, where a financial account does not meet the criterion if the anticipated distribution of funds of the financial account would result in less than all of the funds being distributed among the one or more financial assets.

In general, in another aspect, a system includes an interactive user interface, a database module configured to store information regarding one or more financial accounts, a processor, and a computer-readable medium storing instructions. The instructions, when executed by the processor, cause the processor to perform operations including receiving, from the database module, data pertaining to one of more financial accounts, determining, based on the received data, whether each financial account meets one or more criteria, and presenting visually, on an interactive user interface, an indication of the financial accounts that do not meet at least one of the criteria, and an indication of a status of those financial accounts with respect to each of the criteria.

Implementations of this aspect may include or more of the following features.

In some implementations, the operations can further include receiving, via the interactive graphical user interface, an input from a user indicative of the user's selection of a particular financial account, and responsive to receiving the input, presenting visually, on the interactive user interface, information describing corrective actions that can be performed with respect to the selected financial account, such that performance of the corrective actions results in the selected financial account meeting the one or more criteria. The operations further include receiving, via the interactive graphical user interface, a second input from the user, and responsive to receiving the second input, determining that the corrective actions were performed. The operations can further include, responsive to determining that the corrective actions were performed, presenting visually, on the interactive user interface, an indication of an updated status of the selected financial accounts with respect to each of the criteria.

In some implementations, at least one criterion can pertain to one or more documents associated with establishing a financial account, where a financial account does not meet the criterion if any of the one or more documents for the financial account is deemed to be missing based on the received data. The corrective actions can include providing the one or more documents that are deemed to be missing.

In some implementations, at least one criterion can pertain to one or more documents associated with establishing a financial account, where a financial account does not meet the criterion if any of the one or more documents for the financial account is deemed to be illegible based on the received data. The corrective actions can include providing one or more replacement documents for the one or more documents that are deemed to be illegible.

In some implementations, at least one criterion can pertain to a monetary balance of a financial account, where a financial account does not meet the criterion if the monetary balance for the financial account is less than or equal to a threshold balance.

In some implementations, at least one criterion can pertain to an anticipated distribution of funds of a financial account with respect to one or more financial assets, where a financial account does not meet the criterion if the anticipated distribution of funds of the financial account would result in less than all of the funds being distributed among the one or more financial assets.

In general, in another aspect, a system includes a communications module, a display module, a processor, and a computer-readable medium storing instructions. The instructions, when executed by the processor, cause the processor to perform operations in response to receiving a first set of data from a server computer via the communications module. The first set of data includes information regarding one or more financial accounts that do not meet one or more criteria, and information regarding a status of those financial accounts with respect to each of the one or more criteria. The operations include generating an interactive user interface based on the first set of data, the interactive user interface including an indication of the one or more financial accounts that do not meet one or more criteria, and an indication of the status of those financial accounts with respect to each of the one or more criteria, and displaying the interactive user interface using the display module.

In some implementations, the operations can further include, responsive to receiving, via the interactive graphical user interface, an input from a user indicative of the user's selection of a particular financial account. The operations can further include retrieving, from the server computer via the communications module, a second set of data. The second set of data can include information describing corrective actions that can be performed with respect to the selected financial account, such that performance of the corrective actions results in the selected financial account meeting the one or more criteria. The operations can further include updating the interactive user interface based on the second set of data to include an indication of the corrective actions, and responsive to updating the interactive user interface, displaying the updated interactive user interface using the display module.

The details of one or more implementations are set forth in the accompanying drawings and the description below. Other aspects, features and advantages will be apparent from the detailed description and drawings, and from the claims.

### BRIEF DESCRIPTION OF DRAWINGS

FIG. 1 is a schematic diagram of an example system for assessing financial accounts.

FIG. 2 shows an example account analysis module.

FIG. 3 shows an example summary user interface element.

FIG. 4 shows an example list user interface element.

FIGS. 5, 6A 6B, 7A, 7B, 8 and 9 show various aspects of an example account user interface element.

FIG. 10 shows an example report user interface element.

FIG. 11 shows a schematic diagram of an example account analysis module, database modules, customer portal module, and professional portal module.

FIG. 12 shows a schematic diagram of an example computer system.

### DETAILED DESCRIPTION

This disclosure describes various implementations for assessing the status of financial accounts, and identifying financial accounts that are not in good order. Financial accounts that are not in good order can include, for example, financial accounts that are undergoing an account activation process, but are still pending activation due to one or more issues. Example issues can include, for instance, missing, illegible, or otherwise unreadable documentation, insufficient funding, missing information, or other issues preventing the account from being fully activated. Implementations also can be used to identify corrective actions that can be performed with respect to the financial accounts, such that the financial accounts are placed in good order and fully activated.

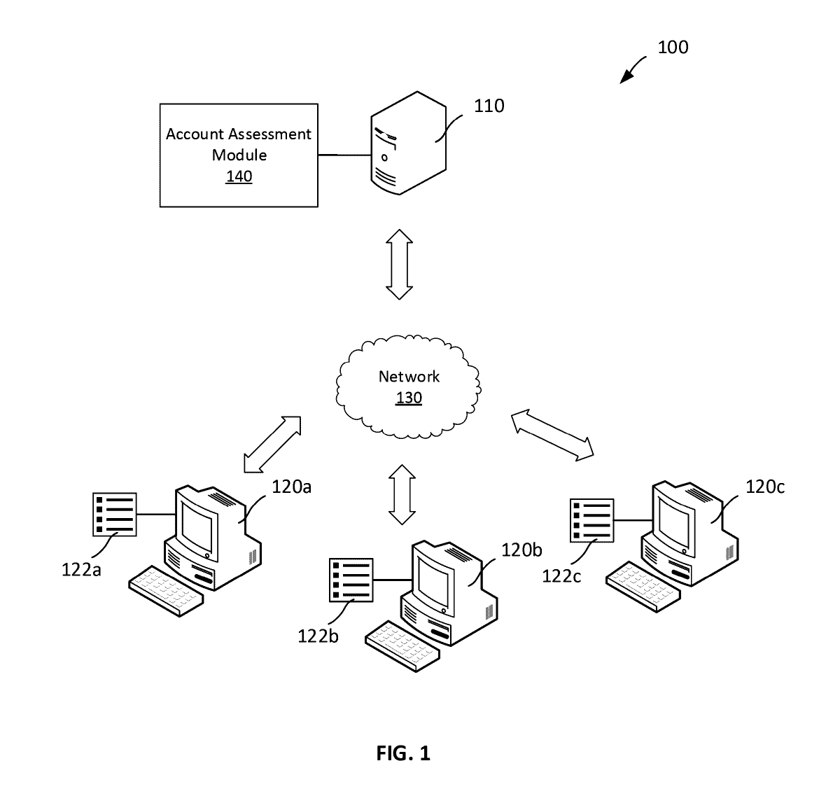

An example system 100 for assessing financial accounts is shown in FIG. 1. In some implementations, the system 100 can be used by a single user. In some cases, a single user can use the system 100 to assess one or more financial accounts, and perform corrective actions with respect to those financial accounts. In others cases, the system 100 can be used by multiple users to assess and perform corrective actions with respect to one or more financial accounts. As an example, multiple agents of a financial institution can use the system 100 to monitor the status of financial accounts managed by the financial institution, identify financial accounts that are not in good order, and perform corrective actions to place those financial accounts in good order.

The system 100 includes a server system 110 and client devices 120a-c that are communicatively connected through a network 130. The system 100 also includes an account assessment module 140 maintained on the server system 110.

Each client device 120a-c includes a user interface 122a-c. Users can interact with the user interfaces 122a-c to view data (e.g., data on the server system 110 and the analysis module 140 and/or data on client devices 120a-b), transmit data to other devices (e.g., to the server system 110 and the account assessment module 140 and/or to other client devices 120a-c), and issue commands (e.g., to the server system 110 and the account assessment module 140 and/or or to the client devices 120a-c). In some implementations, a user may install a software application (e.g., a general web browser or a dedicated software application) onto a client device 120a-c to facilitate performance of these tasks.

The server system 110 transmits information to and/or receives information from the client computers 120a-c. The server system 110 is illustrated as a single component, but can be implemented on one or more computing devices. The server system 110 can be, for instance, a single computing device that is connected to the network 130, and the account assessment module 140 can be maintained and operated on the single computing device. In some implementations, the server system 110 can include multiple computing devices that are connected to network 130, and the account assessment module 140 can be maintained and operated on some or all of the computing devices. For instance, the server system 110 can include several computing devices, and the account assessment module 140 can be distributive on one or more of these computing devices. In some implementations, the server system 110 need not be located locally with respect to the rest of system 100, and portions of the server system 110 can be located at one or more remote physical locations.

A client device 120a-c can be any electronic device that is used by a user to view, process, transmit and receive data. Examples of client devices 120a-c include computers (e.g., desktop computers, notebook computers, server systems, etc.), mobile computing devices (e.g., cellular phones, smartphones, tablets, personal data assistants, notebook computers with networking capability), and other computing devices capable of transmitting and receiving data from the network 130. The client devices 120a-c can include devices that operate using one or more operating systems (e.g., Microsoft Windows, Apple OSX, Linux, Unix, Android, iOS, etc.) and/or architectures (e.g., x86, PowerPC, ARM, etc.) In some implementations, one or more client devices 120a-c need not be located locally with respect to the rest of system 100, and one or more client devices 120a-c can be located at one or more remote physical locations.

The network 130 can be any communications network through which data can be transferred and shared. For example, the network 130 can be a local area network (LAN) or a wide-area network (WAN), such as the Internet. The network 130 can be implemented using various networking interfaces, for instance wireless networking interfaces (e.g., Wi-Fi, Bluetooth, or infrared) or wired networking interfaces (e.g., Ethernet or serial connection). The network 130 also can include combinations of more than one network, and can be implemented using one or more networking interfaces.

In general, the account assessment module 140 monitors the status of financial accounts. As an example, the account assessment module 140 can receive and store information pertaining to one or more financial accounts. The account assessment module 140 also can process this information, and present it to a user (e.g., an agent of the financial account, such as an administrator or a customer service representative), such that the user can more readily identify and understand key aspects of the information. As an example, the account assessment module 140 can interpret the information to generate a summary of each of the financial accounts, identify financial accounts that are not in good order, and provide an explanation as to why those financial accounts are not in good order. The account analysis module 140 also can suggest corrective actions that the user can perform, such that those financial accounts are placed in good order.

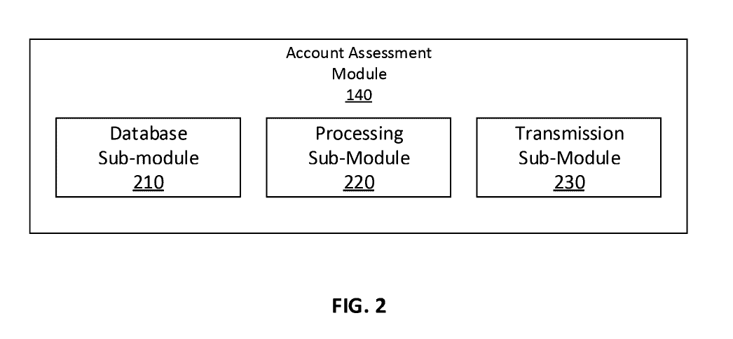

FIG. 2 shows various aspects of the account analysis module 140. The account analysis module 140 includes several sub-modules that perform particular functions related to the operation of the system 100. For example, the account analysis module 140 can include a database module 210, processing sub-module 220, and a transmission sub-module 230. Although FIG. 2 illustrates several sub-modules that are contained within the account assessment module 140, this is merely a simplified example to illustrate the functionality of the account assessment module 140. In practice, one or more of the sub-modules of the account assessment module 140 can be implemented as modules that are separate from the account assessment module 140 (e.g., general purpose modules on the server computer 110), and the account assessment module 140 access those modules to perform various functions or tasks.

The database sub-module 210 maintains information related to one or more financial accounts. For instance, the database sub-module 210 can store information pertaining to the holder of each financial account (e.g., a customer's name, address, contact information, demographical information). The database sub-module 210 also can store information pertaining to the assets held in the financial account (e.g., the name and value of each asset held in a financial account, information regarding transactions performed with respect to the assets held in the financial account, current and historical balances of the financial account, and so forth). The database sub-module 210 also can store information pertaining to documentation associated with each financial account (e.g., contracts or agreements between the account holder and the financial institution, records of communications between the account holder and the financial institution, or other documentation related to the financial account, the holder of the financial account, and the financial institution).

The processing sub-module 220 processes data stored by or otherwise accessible to the system 100. For instance, the processing sub-module 220 can execute automated or user-initiated processes that manipulate data pertaining to one or more financial accounts. As an example, the processing module 220 can manipulate data stored on the database sub-module 210 to generate a summary of the information stored on the database sub-module 210, or an analysis of the information stored on the database sub-module 210. In some cases, the processing sub-module 220 can perform processes that are customized with respect to one or more criteria. For example, in some cases, the processing sub-module 220 can summarize and/or analyze data associated with one or more particular financial accounts, financial account holders, and/or agents of the financial instruction. Example processes that can be performed by the processing sub-module 220 are described in greater detail below.

The transmission sub-module 230 allows for the transmission of data to and from account assessment module 140. For instance, the transmission sub-module 230 can be communicatively connected to network 130, such that it can transmit data to the client devices 120a-c and/or receive data from the client devices 120a-c via network 130. As an example, information inputted by users on the client devices 120a-c can be transmitted to the analysis module 140 through the transmission sub-module 230. This information can then be processed (e.g., using the processing sub-module 220) and/or stored (e.g., using the database sub-module 210). As another example, information from the account assessment module 140 (e.g., information stored on the database sub-module 210) can be transmitted to one or more client devices 120a-c through transmission sub-module 230.

As described above, the account assessment module 140 monitors the status of financial accounts, and displays this information to a user (e.g., an agent of a financial institution, such as an administrator or a customer service representative) for review. This information can be presented, for example, using the user interfaces 122a-c on the client devices 120a-c. As an example, information obtained from the account assessment module 140 (e.g., information stored by the database sub-module 210 and/or information received by the transmission sub-module 230) and can be used to generate graphical, textual, and/or auditory information (e.g., using the processing sub-module 220). This processed information then can be transmitted to the client computers 120a-c (e.g., using the transmission sub-module 230), and presented to the user using the user interfaces 122a-c.

In some cases, the user interfaces 122a-c can include one or more user interface elements (e.g., visual “windows,” “panels,” “pages,” or “tabs”) that visually represent some or all of this information in a form that can be readily viewed and understood by a user. Users can selectively retrieve certain user interface elements to view particular information of interest. For example, in some cases, the user interfaces 122a-c can include several graphical “windows,” each of which contains particular information. A user can select a particular “window” (e.g., by selecting that window with an input device, such as a keyboard or mouse), such that the information within the selected “window” is presented on the user interface 122a-c. As another example, in some cases, the user interfaces 122a-c can include several graphical “tabs,” each of which corresponds to a particular “page” of information. A user can select a particular “tab” (e.g., by selecting that tab with an input device), such that the information within the corresponding “page” is presented on the user interface 122a-c. Although example implementations of user interface elements are described above, other implementations are also possible.

Although specific user interface elements are described and illustrated, these are merely examples to illustrate types of information that may be received, stored, determined, or presented by the system 100. In practice, the system 100 can include all of the described information or sub-sets of the described information, depending on the implementation. Further, although specific arrangements of user interface elements are described, these also are merely examples to illustrate how information may be arranged and presented by the system 100. In practice, the system 100 can arrange and present information in other ways, depending on the implementation.

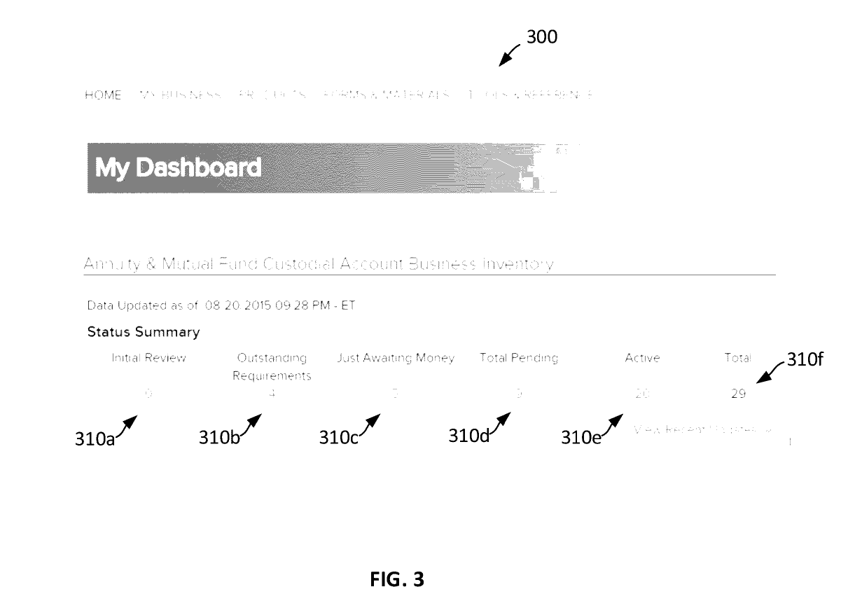

In some implementations, a user interface element can show summary information regarding one or more financial accounts. An example summary user interface element 300 is shown in FIG. 3. The summary user interface element 300 can include one or more sub-elements, each of which presents a particular type of information. For example, the summary user interface element 300 can include a sub-elements 310a-f, each of which displays the number of financial accounts that have a particular corresponding status.

For example, as shown in FIG. 3, the sub-element 310a can display the number of financial accounts that are pending an initial review. Financial accounts that are pending an initial review can be, for example, accounts for which application data has been entered (e.g., information from an account application form that has been recorded by the system 100), but has not yet been reviewed for outstanding issues. The sub-element 310b can display the number of financial accounts that have outstanding requirements. Financial accounts that have outstanding requirements can be, for example, accounts that that do not meet one or more requirements for activating an account (e.g., accounts that are missing, illegible, or otherwise unreadable documentation). The sub-element 310c can display the number of financial accounts that have an insufficient balance, but otherwise have met the other requirements for account activation. The sub-element 310d can display total number of financial accounts that are pending (e.g., the total number of financial accounts that are waiting initial review, have outstanding requirements, or have an insufficient balance). The sub-element 310e can display the number of financial accounts that have met each of the requirements for account activation, including having a sufficient balance. The sub-element 310f can display the total number of financial accounts, both pending and active.

In general, the information shown in the summary user interface element 300 can be determined based on information stored in the database sub-module 210. For example, the database sub-module 210 can contain records describing each aspect of a financial account (e.g., records that include information describing the status of the financial account). Using these records, the processing sub-module 220 can generate the appropriate information for display on the summary user interface element 300. Records describing the financial accounts can be obtained automatically (e.g., from a record keeping module on the server system 110, or from a record keeping system communicatively coupled to the system 100), and/or manually entered by a user (e.g., a user inputting data using the server system 110, client computers 120a-c, or some other device).

A user can interact with the summary user interface element 300 to access information regarding financial accounts having a particular status. For example, a user can select the sub-element 310b (e.g., by clicking, tapping, or otherwise selecting the sub-element 310b using an input device) to access information regarding financial accounts that have outstanding requirements. As another example, a user can select the sub-element 310e (e.g., by clicking, tapping, or otherwise selecting the sub-element 310e using an input device) to access information regarding financial accounts that are pending (e.g., accounts that are pending initial review, have outstanding requirements, and/or have insufficient balance).

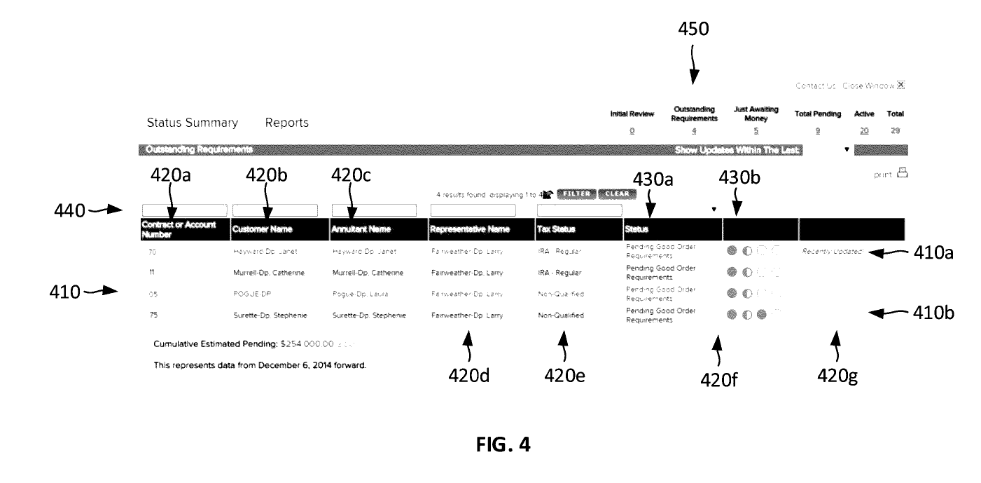

In response to the user selection, the user interface can update to show detailed information regarding each financial account having the selected status. For example, as shown in FIG. 4, in response to a user selecting one the sub-element 310b (corresponding to the number of financial accounts that have outstanding requirements), a list user interface element 400 showing detailed information regarding the accounts can be displayed. As shown in FIG. 4, the list user interface element 400 can display rows 410, each representing a different financial account. Each row 410 can include identification numbers 420a (e.g., contract or account numbers), names of customers 420b, names of annuitants 420c, names of representatives 420d (e.g., names of customer service representatives), tax statuses 420e, account statuses 420f, and update statuses 420g associated with each of the accounts.

The information shown in the list user interface element 400 also can be determined based on information stored in the database sub-module 210. For example, the database sub-module 210 can contain records describing each aspect of a financial account (e.g., records that include the information 420a-g for the financial account). Using these records, the processing sub-module 220 can generate the appropriate information for display on the summary user interface element 300. Records describing the financial accounts can be obtained automatically (e.g., from a record keeping module on the server system 110, or from a record keeping system communicatively coupled to the system 100), and/or manually entered by a user (e.g., a user inputting data using the server system 110, client computers 120a-c, or some other device).

The status of each account can be representing textually (e.g., using a text label describing the status) and/or visually (e.g., using one or more graphical symbols, such as icons, describing the status). For example, as shown in FIG. 4, the account status 420f of each account can be represented using both a textual label 430a and a series of graphical symbols 430b. The textual label 420 can indicate, for instance, similar account statuses as shown in the user interface element 300 (e.g., a generalized status), and while the series of graphical symbols 430b can indicate whether the financial account has met specific requirements for account activation. For example, there may be multiple different criteria for activating an account, and the series of graphical symbols 430b can indicate when an account has met a particular requirement (e.g., by displaying a representative graphical symbol, such as a filled in circle), when an account has partially met a requirement (e.g., by displaying another representative graphical symbol, such as a partially filled in circle), and when an account has neither fully nor partially met a requirement (e.g., by displaying another representative graphical symbol, such as an empty in circle). This can be useful, for example, as it allows a user to visually determine not only which financial accounts have not met certain requirements, but also the requirements that have not been met.

As an example, row 410a indicates that a first financial account has fulfilled the first requirement for account activation, has partially fulfilled the second requirement for account activation, and has not fulfilled the third and fourth requirements for account activation (represented as a series of graphical symbols in which the first circle is fully filled in, the second circle is partially filled in, and the third and fourth circles are empty). As another example, row 410b indicates that a second financial account has fulfilled the first and third requirements for account activation, has partially fulfilled the second requirement for account activation, and has not fulfilled the fourth requirement for account activation (represented as a series of graphical symbols in which the first and third circles are filled in, the second circle is partially filled in, and the fourth circle is empty).

The account assessment module 140 can determine whether a financial account has fulfilled certain requirements in various ways. For example, in some cases, the account assessment module 140 can identify whether a financial account has met one or more requirements based on input from a user. For example, in some cases, a user can manually review information associated with each financial account, and identify, to the account assessment module, whether certain criteria have been met. In some cases, the account assessment module 140 can determine whether a financial account has met one or more requirements based on both an automatic determination and a manual determination by a user.

The number, order and type of requirements depicted by the series of graphical symbols 430b can vary, depending on the implementation. For example, as shown in FIG. 4, the series of graphical symbols 430b can depict four different requirements (described in further detail below). However, different requirements and combinations of requirements are also possible.

The list user interface element 400 also can include filtering sub-elements 440 that allow a user to filter the information shown in the list user interface element 400. For example, a user can enter filtering criteria into the filtering sub-elements 440 (e.g., particular identification numbers, customer names, annuitants names, representative names, and/or tax statuses), and in response, the list user interface element 400 can show only the financial accounts that meet the filtering criteria.

The list user interface element 400 also can include a summary sub-element 450. The summary sub-element 450 can be similar to the summary user interface element 300. For example, the summary sub-element 450 can display the number of financial accounts that have a particular status. Likewise, a user select a particular status to review detailed information regarding the financial accounts having the selected status.

A user can interact with the list user interface element 400 to access information regarding a specific financial accounts. For example, a user can select one of the rows 410 (e.g., by clicking, tapping, or otherwise selecting the row using an input device) to access information regarding the financial accounts displayed on that row.

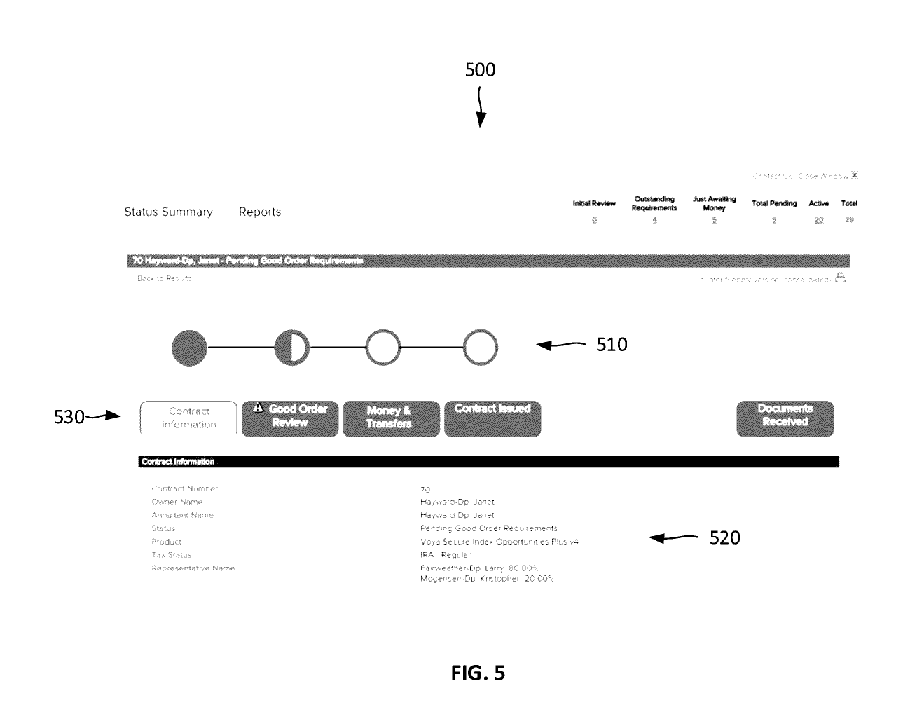

In response to the user selection, the user interface can update to show detailed information regarding the selected financial account. For example, as shown in FIG. 5, in response to a user selecting one the rows 410, the user interface can display an account user interface element 500 showing detailed information regarding the selected account. As shown in FIG. 5, the account user interface element 500 can display a series of graphical symbols 510 that indicates whether the financial account has met specific requirements for account activation. The series of graphical symbols 510 can be similar to the series of graphical symbols 430b shown in FIG. 4.

The account user interface element 500 can display information regarding one of the requirements for account activation. For example, as shown in FIG. 5, the account user interface element 500 can display information regarding account information, and provide an indication whether the account information has been properly and fully entered. In the example shown in FIG. 5, the account information 520 has been properly and fully entered (e.g., each of the required account information fields has been populated with valid information). Thus, the first circle of the series of graphical symbols 510 is filled in, indicating that the account information requirement has been fully met.

If the account information has not been properly and fully entered, the account user interface element 500 can identify particular fields that have been not properly entered (e.g., by highlighting, boxing, or otherwise identifying those fields), and provide the user with an opportunity to correct the error (e.g., by providing an input box or dialog for entering new or replacement information). The user interface element 500 can update to reflect the user's input (e.g., by updating the status information for the financial account).

A user can navigate the account user interface element 500 to access information regarding each of the requirements. For example, while viewing information regarding the first requirement (e.g., as shown in FIG. 5), a user can select a second requirement (e.g., by selecting the second circle of the series of graphical symbols 510 or the second tab in the series of tabs 530).

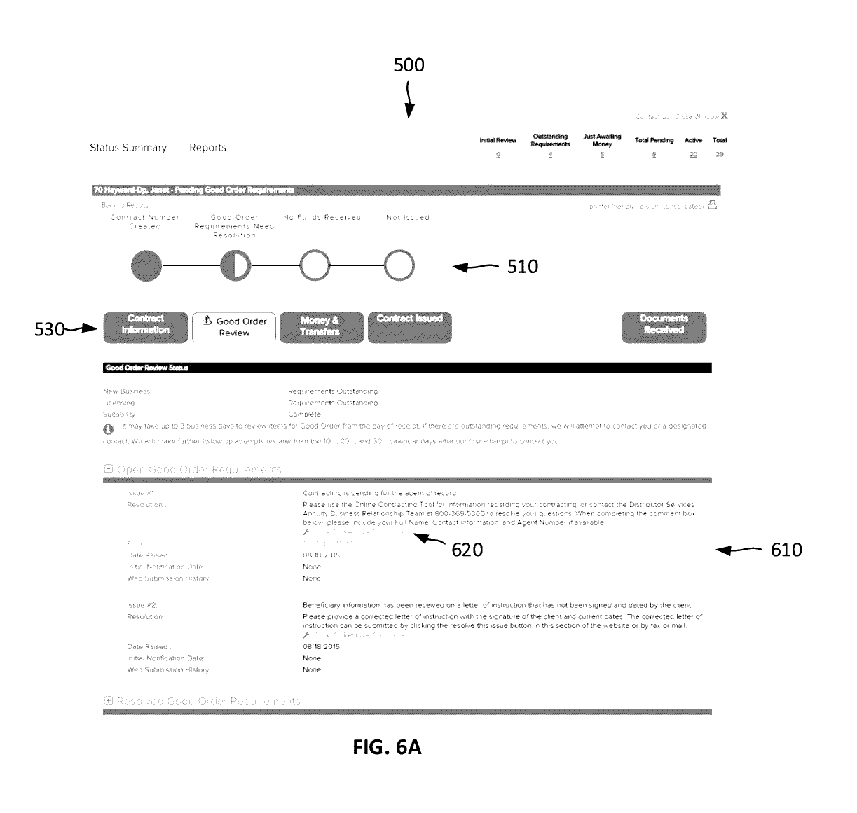

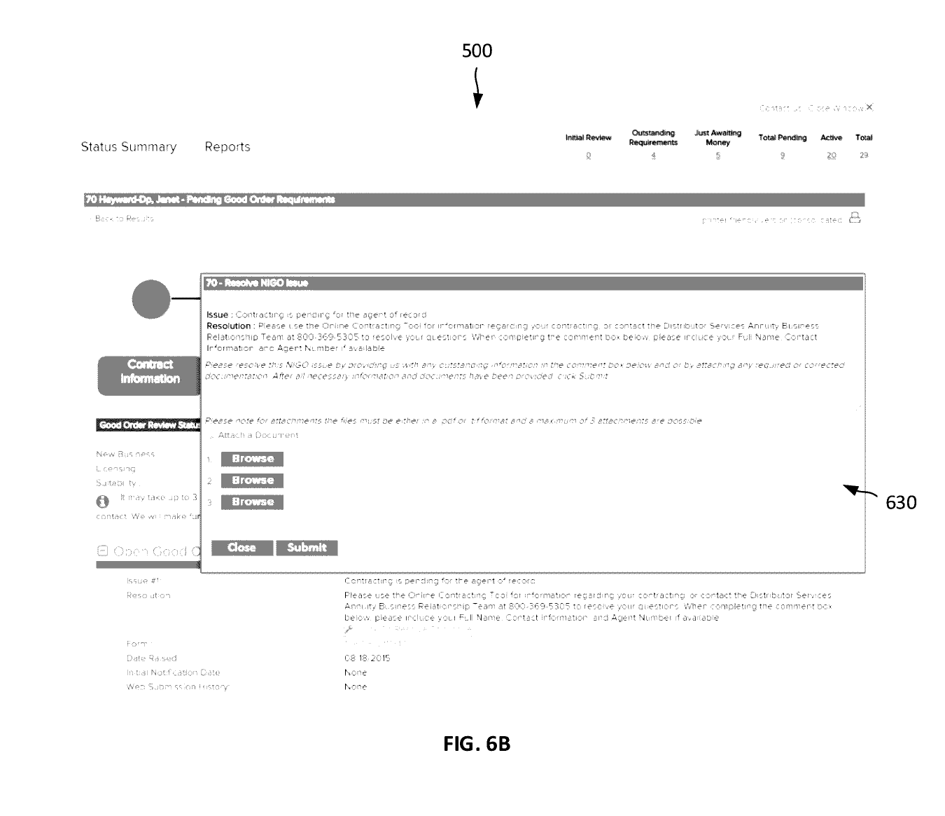

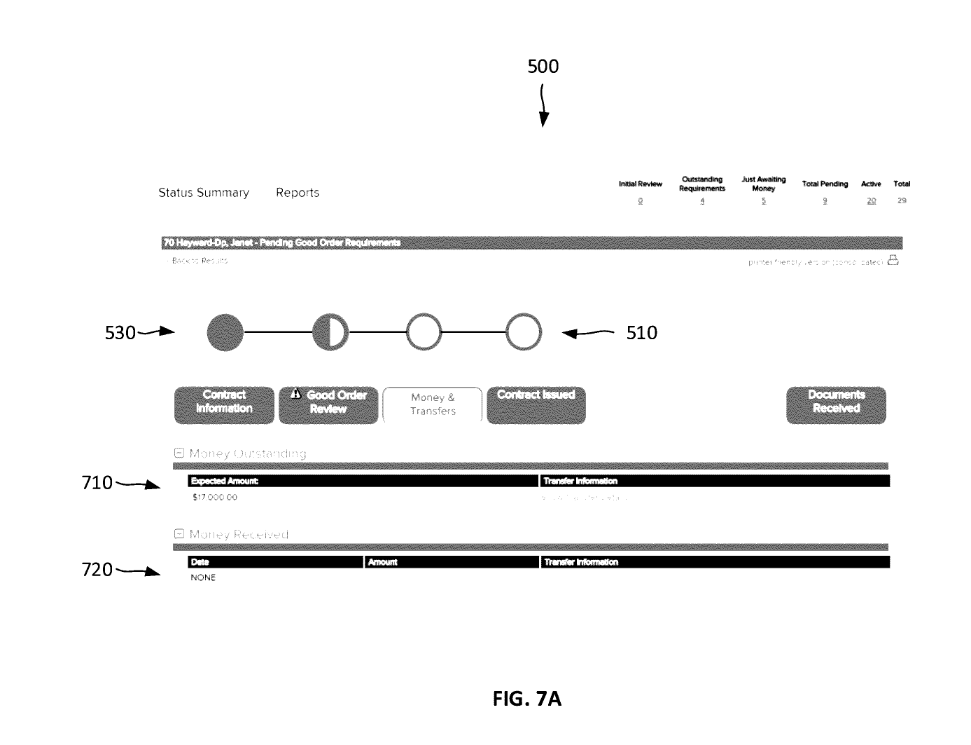

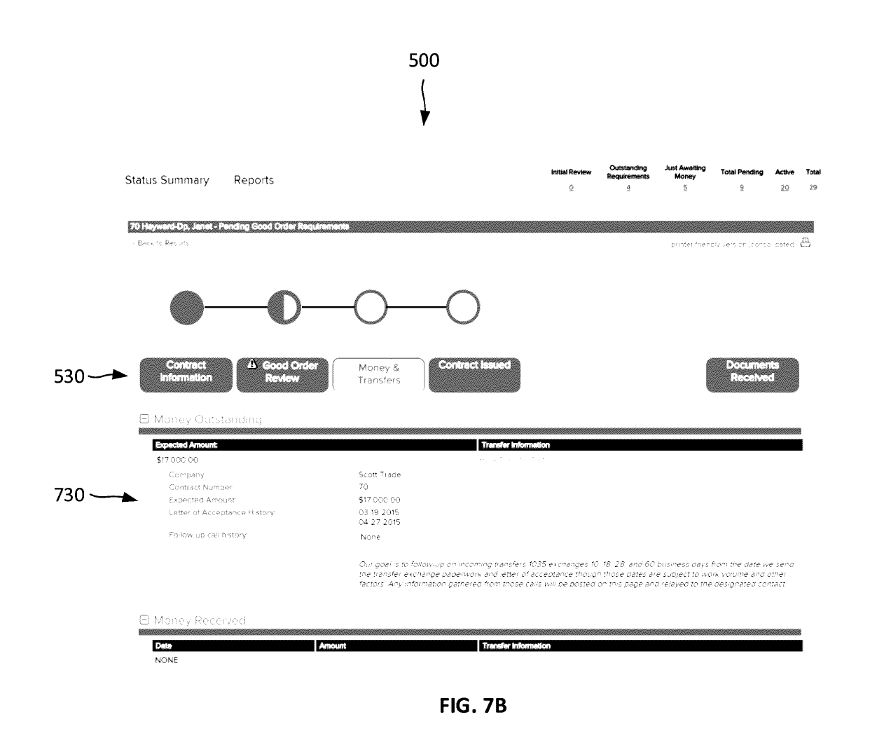

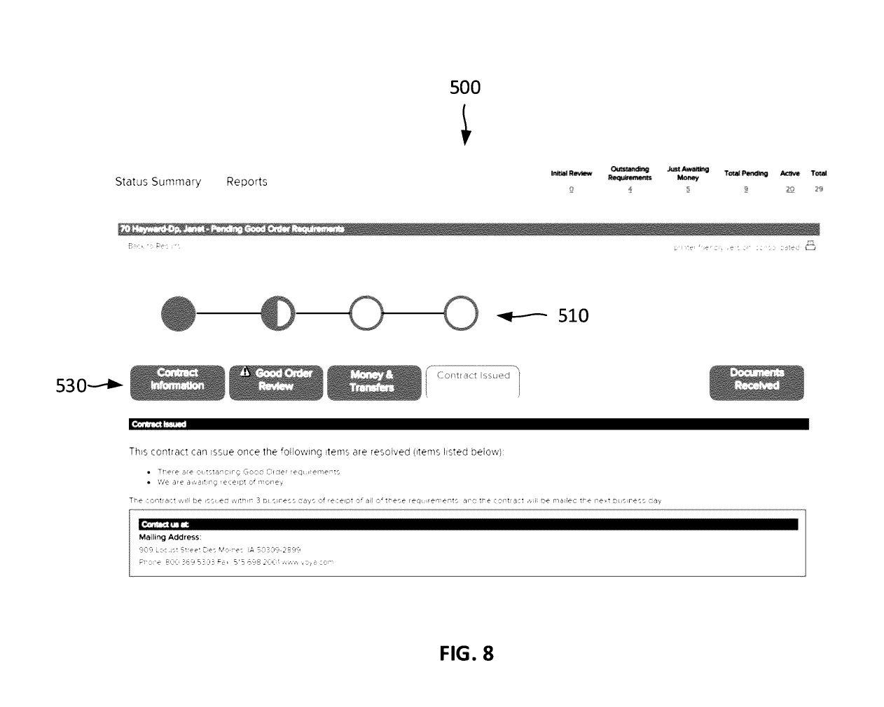

In response, as shown in FIG. 6A, the account user interface element 500 can update to show detailed information regarding the selected financial account with respect to the second requirement. As an example, as shown in FIG. 6A, the account user interface element 500 can display information regarding the results of a “good order” review, and provide an indication whether the financial account has met each of the criteria for the good order review. In the example shown in FIG. 6A the financial account has only partially met the criteria for the good order review. Thus, the second circle of the series of graphical symbols 510 is partially filled in, indicating that the account information requirement has been only partially met.

A good order review can include one or more different criteria. For example, to fully activate a financial account, a user may need to provide various forms of documentation (e.g., contracts, agreements, or other documentation). If any of these documents are missing, illegible, unreadable, or otherwise unsatisfactory, the financial account may not fulfill the criterion. For example, to fully activate a financial account, a user may need to provide various forms of documentation (e.g., contracts, agreements, or other documentation). If any of these documents are missing, illegible, unreadable, or otherwise unsatisfactory, the financial account may not fulfill the criterion. As another example, if an incorrect document was provided, the financial account may not fulfill the criterion. As another example, if a document includes incorrect information, the financial account may not fulfill the criterion.

As another example, an account may be asked to provide an anticipated distribution of funds of a financial account with respect to one or more financial assets. If the anticipated distribution of funds of the financial account would result in less than all of the funds being distributed among the one or more financial assets, the financial account may be not fulfill the criterion. For example, a customer may indicate that he anticipates that 75% of the funds of financial account will be held as a first financial asset, and 25% of the funds of financial account will be held as a second financial asset. In this case, the financial account may fulfill the criterion. However, a customer may indicate that he anticipates that 70% of the funds of financial account will be held as a first financial asset, and 20% of the funds of financial account will be held as a second financial asset. In this case, the financial account may not fulfill the criterion, as the customer has not provided an indication regarding the anticipated distribution of 10% of the funds.

If the financial account has not fulfilled each of the criteria of the good order review, the account user interface element 500 can identify and describe the outstanding issue. For instance, in the example shown in FIG. 6A, required information (e.g., the applicant state) is missing, illegible, or incorrectly provided on one of the documents associated with the financial account (e.g., a “Nexus” form). The account user interface element 500 identifies and describes the issue in the issue sub-element 610, such that the user can ascertain the missing information. For example, the issue sub-element 610 can provide a brief summary of the issue (e.g., in the form of a message or note), indicate when the issue was raised, and describe a history of the issue (e.g., when a user was initial notified of the issue, a history of submissions that were performed with respect to the issue). The issue sub-element 610 also can provide suggestions for resolving the issue. For example, as shown in FIG. 6A, the issue sub-element 610 can suggest that the user provide a corrected Nexus form with the applicant state information completed, and provide the user with a submission sub-element 620 to submit the document.

As shown in FIG. 6B, when the user selects the submission sub-element 620, the account user interface element 500 can update to provide the user with a submission dialog 630. Using the submission dialog 630, the user can review information regarding the issue (including the suggested corrective action for resolving the issue), then submit a document to resolve the issue. As shown in FIG. 6B, the submission dialog 630 can allow a user to browse for and select one or more files on his device (e.g., by presenting a file browser that allows the user to navigate through a file system), then submit the selected files to the assessment module 140. The user interface element 500 can update to reflect the user's input (e.g., by updating the status information for the financial account).

As described above, a user can navigate the account user interface element 500 to access information regarding each of several requirements. As another example, while viewing information regarding the one of the requirements (e.g., as shown in FIG. 5 or 6A), a user can select a third requirement (e.g., by selecting the third circle of the series of graphical symbols 510 or the third tab in the series of tabs 530).

In response, as shown in FIG. 7A, the account user interface element 500 can update to show detailed information regarding the selected financial account with respect to the third requirement. As an example, as shown in FIG. 7A, the account user interface element 500 can display information regarding whether the financial account has fulfilled requirements with respect to the balance of the financial account. In some cases, a financial account may not be fully activated until a particular balance (e.g., a positive balance or some other minimum threshold balance) is established on the financial account. If the financial account does not meet this requirement, the account user interface element 500 can indicate the requirement has not been fulfilled. For instance, in the example shown in FIG. 7A, funds are expected to be transferred to the financial institution with respect to the financial account (e.g., as indicated in sub-element 710), but no funds have yet been received (e.g., as indicated in sub-element 720). Therefore, although the financial account is expected to be funded above a minimum acceptable balance (e.g., above zero), the financial account has not yet established the minimum acceptable balance. Thus, the third circle of the series of graphical symbols 510 is empty, indicating that the account information requirement has been not been met. In some cases, if no funds are expected (e.g., no transactions are pending) and the financial account does not have at least the minimum acceptable balance, the account user interface element 500 also can indicate the requirement has not been met (e.g., by displaying a corresponding empty circle in the series of graphical symbols 510).

The user can access additional information regarding the expected and received funds of a financial account. For example, a user can select one or more pending transaction shown in the sub-element 710, and in response, the account user interface element 500 can update to display a transaction dialog providing details regarding the selected pending transaction. For instance, as shown in FIG. 7B, the account user interface element 500 can display a transaction sub-element 730 that displays information regarding the pending transactions, including the company or financial institution from which the funds are being transferred, the account number associated with the transaction, the expected amount of funds that are being transferred, a letter of acceptance history associated with the transfer, and a summary of calls or other communications that were conducted with respect to the transfer.

As another example, while viewing information regarding the one of the requirements (e.g., as shown in FIG. 5, 6A or 7A), a user can select a fourth requirement (e.g., by selecting the fourth circle of the series of graphical symbols 510 or the fourth tab in the series of tabs 530).

In response, as shown in FIG. 8, the account user interface element 500 can update to show detailed information regarding the selected financial account with respect to the fourth requirement. As an example, as shown in FIG. 8, the account user interface element 500 can display information regarding whether the financial account has fulfilled all activation requirements for opening the financial account. For example, the account user interface element 500 can display information regarding whether the financial account has met one or more activation requirements, whether funds have been received and applied to the account, and/or whether a contract has been issued for the account.

The user also can access each of the documents that have been submitted with respect to the financial account. For example, a user can access these documents by selecting the “Documents Received” tab from the series of tabs 530. In response, as shown in FIG. 9, the account user interface element 500 can update to display a documents sub-element 910. The document sub-element 910 can summarize each of the documents that were submitted with respect to the financial account (e.g., documents that were provided by the account holder, the financial institution, or an agent of the financial institution), and can provide the user with access to each of the submitted documents. For example, a user can select one or more of the documents displayed in the document sub-element 910 to review the selected documents. If no documents have been submitted with respect to the financial account, the documents sub-element 910 can display a message indicating that no documents have been submitted.

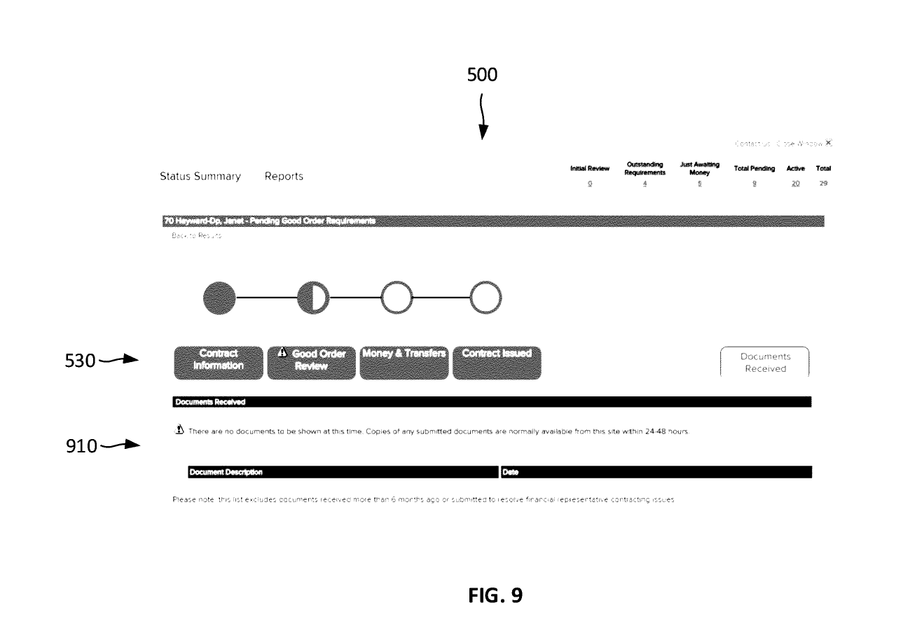

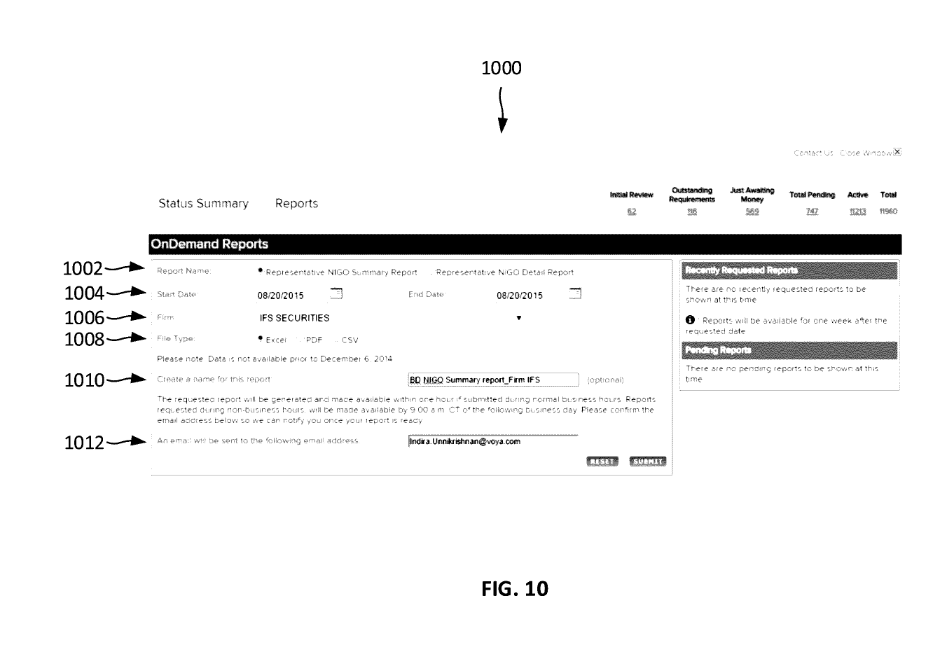

In some implementations, a user can generate one or more reports containing information regarding one or more financial accounts. For example, as shown in FIG. 10, the user interface can include a report user interface element 1000. A user can access the report user interface element 1000, for example, by selecting the “Reports” label shown displayed in the account user interface element 500. The report user interface element 1000 presents the user with one or more criteria for generating a report. For example, as shown in FIG. 1000, the report user interface element 1000 can include an element 1002 that allows the user to select a type of report to generate (e.g., a summary report having a relatively small amount of information, or a detailed report having a relatively large amount of information), an element 1004 that allows the user to select a range of dates for which to generate data, an element 1006 that allows the user to specify a particular financial institution or department for which to generate data, and an element 1008 that allows the user to specify a particular file format for the generated report. The report user interface element 1000 also can include an element 1110 that allows the user to specify a name for the report, and an e-mail address to which the generated report will be sent. A report is generated based on the user's selections.

The format and arrangement of reports can vary, as can the information included within it. For example, in some cases, reports can be formatted as one or more tables, charts, documents, and/or spreadsheet. As another example, in some cases, a report can include information regarding one or more accounts, and can include either all of or a subset of the information described above.

Although various information and interface sub-elements are described above, these are merely illustrative examples. In practice, a user interface 500 can include additional information or sub-elements, either in addition to or instead of those described above. Further, although example arrangements of information and interface sub-elements are shown and describe, these are merely illustrative examples. In practice, a user interface can have any suitable arrangement, depending on the implementation.

Further, although a simplified example of an account analysis module 140 is shown above (e.g., with respect to FIG. 2), these are merely simplified examples to illustrate the functionality of the account assessment module 140. In practice, one or more of the sub-modules of the account assessment module 140 can be implemented as modules that are separate from the account assessment module 140 (e.g., general purpose modules on the server computer 110), and the account assessment module 140 access those modules to perform various functions or tasks.

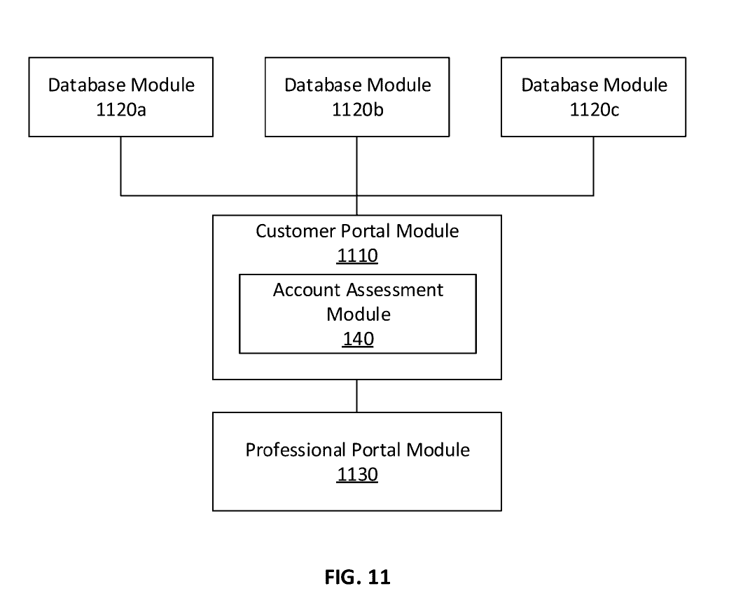

For example, referring to FIG. 11 in some cases, the account assessment module 140 can be implemented as a part of a customer portal module 1110. A customer portal module 1110 can be, for example, a module of a server system 100 that accesses information regarding one or more financial accounts (e.g., information stored on one or more database modules 1120a-c), processes the information (e.g., to generate summaries of the financial accounts), and provides users with access to the information (e.g., through a portal interface). Further, a professional portal module 1130 can access information from the customer portal module 1110 to provide limited subset of users (e.g., agents of a professional institution, such as administrators or customer service representatives) with access to potentially sensitive information (e.g., information from the account assessment module regarding one or more financial accounts). In this manner, the functionality of the account assessment module 140 can be provided as a part of other modules, and the account assessment module 140 need not be provided as a discrete, separate, or stand-alone module. Further, the account assessment module 140 need not specifically include each of sub-modules described with respect to FIG. 2, and instead can stores, access, process, and/or transmit data using modules separate from the account assessment modules 140.

Some implementations described in this specification can be implemented as one or more groups or modules of digital electronic circuitry, computer software, firmware, or hardware, or in combinations of one or more of them. Although different modules can be used, each module need not be distinct, and multiple modules can be implemented on the same digital electronic circuitry, computer software, firmware, or hardware, or combination thereof.

Some implementations described in this specification can be implemented as one or more computer programs, i.e., one or more modules of computer program instructions, encoded on computer storage medium for execution by, or to control the operation of, data processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium also can be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus also can include, in addition to hardware, code that creates an execution environment for the computer program in question, e.g., code that constitutes processor firmware, a protocol stack, a database management system, an operating system, a cross-analysis runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages. As example, a computer program can be written in one or more of C, Java, Object-C, C++, C#, PHP, JavaScript, Python, Visual Basic, Perl, and/or any other suitable language. In some cases, a computer program can be partially or entirely written using macros that specify how certain input sequences should be mapped to a particular output sequences. In some cases, a computer program can be implemented as a part of another computer program, such as a general purpose office productivity application. As an example, a computer program can be written such that it can be executed by a general purpose spreadsheet application (e.g., Microsoft Excel), a general purpose word processor application (e.g., Microsoft Word), or a general purpose database application (e.g., Microsoft Access).

A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows also can be performed by, and apparatus also can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and processors of any kind of digital computer. Generally, a processor will receive instructions and data from a read only memory or a random access memory or both. A computer includes a processor for performing actions in accordance with instructions and one or more memory devices for storing instructions and data. A computer may also include, or be operatively coupled to receive data from or transfer data to, or both, one or more mass storage devices for storing data, e.g., magnetic, magneto optical disks, or optical disks. However, a computer need not have such devices. Devices suitable for storing computer program instructions and data include all forms of non-volatile memory, media and memory devices, including by way of example semiconductor memory devices (e.g., EPROM, EEPROM, flash memory devices, and others), magnetic disks (e.g., internal hard disks, removable disks, and others), magneto optical disks, and CD ROM and DVD-ROM disks. The processor and the memory can be supplemented by, or incorporated in, special purpose logic circuitry.

To provide for interaction with a user, operations can be implemented on a computer having a display device (e.g., a monitor, or another type of display device) for displaying information to the user and a keyboard and a pointing device (e.g., a mouse, a trackball, a tablet, a touch sensitive screen, or another type of pointing device) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A computer system may include a single computing device, or multiple computers that operate in proximity or generally remote from each other and typically interact through a communication network. Examples of communication networks include a local area network (“LAN”) and a wide area network (“WAN”), an inter-network (e.g., the Internet), a network comprising a satellite link, and peer-to-peer networks (e.g., ad hoc peer-to-peer networks). A relationship of client and server may arise by virtue of computer programs running on the respective computers and having a client-server relationship to each other.

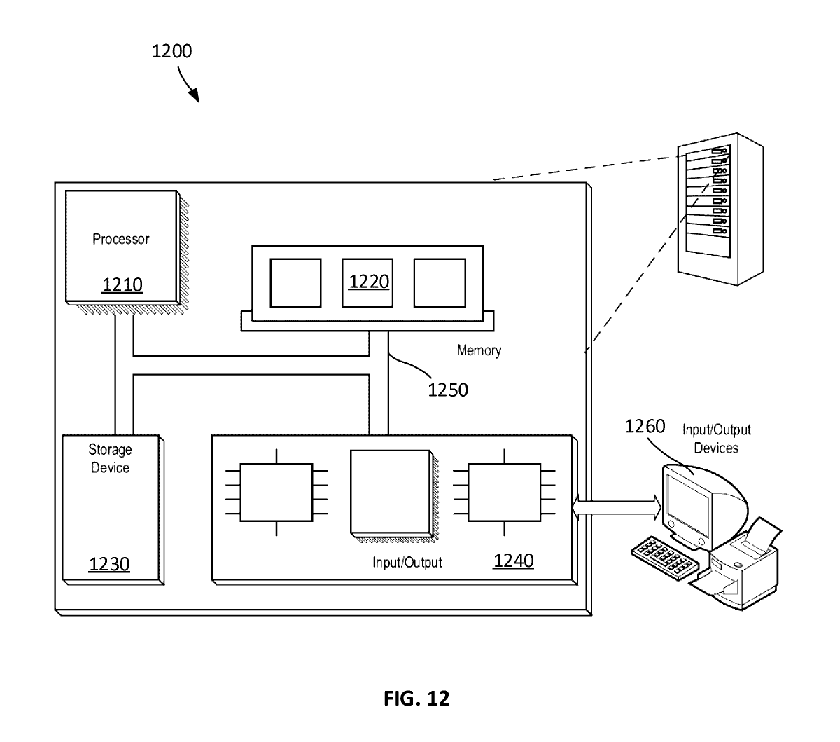

FIG. 12 shows an example computer system 1200 that includes a processor 1210, a memory 1220, a storage device 1230 and an input/output device 1240. Each of the components 1210, 1220, 1230 and 1240 can be interconnected, for example, by a system bus 1250. The processor 1210 is capable of processing instructions for execution within the system 1200. In some implementations, the processor 1210 is a single-threaded processor, a multi-threaded processor, or another type of processor. The processor 1210 is capable of processing instructions stored in the memory 1220 or on the storage device 1230. The memory 1220 and the storage device 1230 can store information within the system 1200.

The input/output device 1240 provides input/output operations for the system 1200. In some implementations, the input/output device 1240 can include one or more of a network interface devices, e.g., an Ethernet card, a serial communication device, e.g., an RS-232 port, and/or a wireless interface device, e.g., an 802.11 card, a 3G wireless modem, a 4G wireless modem, etc. In some implementations, the input/output device can include driver devices configured to receive input data and send output data to other input/output devices, e.g., keyboard, printer and display devices 1260. In some implementations, mobile computing devices, mobile communication devices, and other devices can be used.

While this specification contains many details, these should not be construed as limitations on the scope of what may be claimed, but rather as descriptions of features specific to particular examples. Certain features that are described in this specification in the context of separate implementations also can be combined. Conversely, various features that are described in the context of a single implementation also can be implemented in multiple embodiments separately or in any suitable subcombination.

A number of implementations have been described. Nevertheless, it will be understood that various modifications may be made without departing from the spirit and scope of the invention. Accordingly, other implementations are within the scope of the following claims.

What is claimed is:

1. A method comprising:
receiving, at a processing module from a database module, data pertaining to one of more financial accounts;
determining, by the processing module based on the received data, whether each financial account meets one or more criteria;
presenting visually, on an interactive user interface, an indication of the financial accounts that do not meet at least one of the criteria, and an indication of a status of those financial accounts with respect to each of the criteria.

2. The method of claim 1, further comprising:
receiving, via the interactive graphical user interface, an input from a user indicative of the user's selection of a particular financial account; and
responsive to receiving the input, presenting visually, on the interactive user interface, information describing corrective actions that can be performed with respect to the selected financial account, such that performance of the corrective actions results in the selected financial account meeting the one or more criteria.

3. The method of claim 2, further comprising:
receiving, via the interactive graphical user interface, a second input from the user; and
responsive to receiving the second input, determining that the corrective actions were performed.

4. The method of claim 3, further comprising:
responsive to determining that the corrective actions were performed, presenting visually, on the interactive user interface, an indication of an updated status of the selected financial accounts with respect to each of the criteria.

5. The method of claim 2, wherein at least one criterion pertains to one or more documents associated with establishing a financial account, and wherein a financial account does not meet the criterion if any of the one or more documents for the financial account is deemed to be missing based on the received data.

6. The method of claim 5, wherein the corrective actions comprise providing the one or more documents that are deemed to be missing.

7. The method of claim 2, wherein at least one criterion pertains to one or more documents associated with establishing a financial account, and wherein a financial account does not meet the criterion if any of the one or more documents for the financial account is deemed to be illegible based on the received data.

8. The method of claim 7, wherein the corrective actions comprise providing one or more replacement documents for the one or more documents that are deemed to be illegible.

9. The method of claim 1, wherein at least one criterion pertains to a monetary balance of a financial account, and wherein a financial account does not meet the criterion if the monetary balance for the financial account is less than or equal to a threshold balance.

10. The method of claim 1, wherein at least one criterion pertains to an anticipated distribution of funds of a financial account with respect to one or more financial assets, and wherein a financial account does not meet the criterion if the anticipated distribution of funds of the financial account would result in less than all of the funds being distributed among the one or more financial assets.

11. A system comprising:
an interactive user interface;
a database module configured to store information regarding one or more financial accounts;
a processor; and
a computer-readable medium storing instructions, which, when executed by the processor, cause the processor to perform operations comprising:
receiving, from the database module, data pertaining to one of more financial accounts;
determining, based on the received data, whether each financial account meets one or more criteria;
presenting visually, on an interactive user interface, an indication of the financial accounts that do not meet at least one of the criteria, and an indication of a status of those financial accounts with respect to each of the criteria.

12. The system of claim 11, wherein the operations further comprise:
receiving, via the interactive graphical user interface, an input from a user indicative of the user's selection of a particular financial account; and
responsive to receiving the input, presenting visually, on the interactive user interface, information describing corrective actions that can be performed with respect to the selected financial account, such that performance of the corrective actions results in the selected financial account meeting the one or more criteria.

13. The system of claim 12, wherein the operations further comprise:
receiving, via the interactive graphical user interface, a second input from the user; and
responsive to receiving the second input, determining that the corrective actions were performed.

14. The system of claim 13, wherein the operations further comprise:
responsive to determining that the corrective actions were performed, presenting visually, on the interactive user interface, an indication of an updated status of the selected financial accounts with respect to each of the criteria.

15. The system of claim 12, wherein at least one criterion pertains to one or more documents associated with establishing a financial account, and wherein a financial account does not meet the criterion if any of the one or more documents for the financial account is deemed to be missing based on the received data.

16. The system of claim 15, wherein the corrective actions comprise providing the one or more documents that are deemed to be missing.

17. The system of claim 12, wherein at least one criterion pertains to one or more documents associated with establishing a financial account, and wherein a financial account does not meet the criterion if any of the one or more documents for the financial account is deemed to be illegible based on the received data.

18. The system of claim 17, wherein the corrective actions comprise providing one or more replacement documents for the one or more documents that are deemed to be illegible.

19. The system of claim 11, wherein at least one criterion pertains to a monetary balance of a financial account, and wherein a financial account does not meet the criterion if the monetary balance for the financial account is less than or equal to a threshold balance.

20. The system of claim 11, wherein at least one criterion pertains to an anticipated distribution of funds of a financial account with respect to one or more financial assets, and wherein a financial account does not meet the criterion if the anticipated distribution of funds of the financial account would result in less than all of the funds being distributed among the one or more financial assets.

21. A system comprising:
a communications module;
a display module;
a processor; and
a computer-readable medium storing instructions, which, when executed by the processor, cause the processor to perform operations in response to receiving a first set of data from a server computer via the communications module, the first set of data comprising:
information regarding one or more financial accounts that do not meet one or more criteria, and
information regarding a status of those financial accounts with respect to each of the one or more criteria;
the operations comprising:
generating an interactive user interface based on the first set of data, the interactive user interface including an indication of the one or more financial accounts that do not meet one or more criteria, and an indication of the status of those financial accounts with respect to each of the one or more criteria; and
displaying the interactive user interface using the display module.

22. The system of claim 21, wherein the operations further comprise:
responsive to receiving, via the interactive graphical user interface, an input from a user indicative of the user's selection of a particular financial account:
retrieving, from the server computer via the communications module, a second set of data, the second set of data comprising information describing corrective actions that can be performed with respect to the selected financial account, such that performance of the corrective actions results in the selected financial account meeting the one or more criteria;
updating the interactive user interface based on the second set of data to include an indication of the corrective actions; and
responsive to updating the interactive user interface, displaying the updated interactive user interface using the display module.
